(19) United States
(12) Patent Application Publication
(10) Pub. No.: US 2025/0184829 A1
(43) Pub. Date: Jun. 5, 2025

(54) DIGITAL NON-LINEARITY MODELING

(71) Applicant: QUALCOMM INCORPORATED, San Diego, CA (US)

(72) Inventors: Igor GUTMAN, Hod HaSharon (IL); Joseph Patrick BURKE, Carlsbad, CA (US); Pushkar Bajirao KULKARNI, San Diego, CA (US); Juergen CEZANNE, Ocean Township, NJ (US); Abdelrahman Mohamed Ahmed Mohamed IBRAHIM, San Diego, CA (US); Junyi LI, Greentown, PA (US)

(21) Appl. No.: 18/862,024

(22) PCT Filed: Jun. 14, 2023
(86) PCT No.: PCT/US2023/068445

§ 371 Date: Oct. 31, 2024

(30) Foreign Application Priority Data
Jun. 29, 2022 (IL) 294389

(51) Int. Cl. H04W 28/18

(52) U.S. Cl. CPC H04W 28/18

(57) ABSTRACT

Various aspects of the present disclosure generally relate to wireless communication. In some aspects, a first node may transmit (510) an indication of a first set of one or more groups, wherein each group of the first set of one or more groups includes respective one or more parameter values corresponding to digital non-linearity transmission modeling supported by the first node. The first node may receive (520) an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception. Numerous other aspects are described.

### CROSS-REFERENCE TO RELATED APPLICATION

This Patent application claims priority to Israeli Patent Application No. 294389, filed on Jun. 29, 2022, entitled “DIGITAL NON-LINEARITY MODELING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for digital non-linearity modeling.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first node. The method may include transmitting an indication of a first set of one or more groups, wherein each group of the first set of one or more groups includes respective one or more parameter values corresponding to digital non-linearity transmission modeling supported by the first node. The method may include receiving an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.

Some aspects described herein relate to a method of wireless communication performed by a first node. The method may include receiving an indication of a first set of one or more groups, wherein each group of the first set of one or more groups includes respective one or more parameter values corresponding to digital non-linearity transmission modeling supported by the first node. The method may include transmitting an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.

Some aspects described herein relate to a first node for wireless communication. The first node may include a memory and one or more processors coupled to the memory. The one or more processors may be configured to transmit an indication of a first set of one or more groups, wherein each group of the first set of one or more groups includes respective one or more parameter values corresponding to digital non-linearity transmission modeling supported by the first node. The one or more processors may be configured to receive an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.

Some aspects described herein relate to a first node for wireless communication. The first node may include a memory and one or more processors coupled to the memory. The one or more processors may be configured to receive an indication of a first set of one or more groups, wherein each group of the first set of one or more groups includes respective one or more parameter values corresponding to digital non-linearity transmission modeling supported by the first node. The one or more processors may be configured to transmit an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.

Some aspects described herein relate to a non-transitory computer-readable medium that stores a set of instructions for wireless communication by a first node. The set of instructions, when executed by one or more processors of the first node, may cause the first node to transmit an indication of a first set of one or more groups, wherein each group of the first set of one or more groups includes respective one or more parameter values corresponding to digital non-linearity transmission modeling supported by the first node. The set of instructions, when executed by one or more processors of the first node, may cause the first node to receive an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.

Some aspects described herein relate to a non-transitory computer-readable medium that stores a set of instructions for wireless communication by a first node. The set of instructions, when executed by one or more processors of the first node, may cause the first node to receive an indication of a first set of one or more groups, wherein each group of the first set of one or more groups includes respective one or more parameter values corresponding to digital non-linearity transmission modeling supported by the first node. The set of instructions, when executed by one or more processors of the first node, may cause the first node to transmit an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.

Some aspects described herein relate to an apparatus for wireless communication. The apparatus may include means for transmitting an indication of a first set of one or more groups, wherein each group of the first set of one or more groups includes respective one or more parameter values corresponding to digital non-linearity transmission modeling supported by the first node. The apparatus may include means for receiving an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.

Some aspects described herein relate to an apparatus for wireless communication. The apparatus may include means for receiving an indication of a first set of one or more groups, wherein each group of the first set of one or more groups includes respective one or more parameter values corresponding to digital non-linearity transmission modeling supported by the first node. The apparatus may include means for transmitting an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of communicating using non-linearity (NL) distortion, in accordance with the present disclosure.

FIGS. 5 and 6 are diagrams illustrating examples associated with digital NL modeling, in accordance with the present disclosure.

FIGS. 7 and 8 are diagrams illustrating example processes associated with digital NL modeling, in accordance with the present disclosure.

FIGS. 9 and 10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure, function, example, aspect, or the like presented throughout this disclosure. This disclosure includes, for example, any structure, function, example, aspect, or the like disclosed herein, whether implemented in independently of or combined with any other aspect of the disclosure. For example, an apparatus may be implemented or a method may be practiced using any number of the aspects set forth herein. In addition, the scope of the disclosure includes such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems are presented with reference to various apparatuses and techniques. These apparatuses and techniques are described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

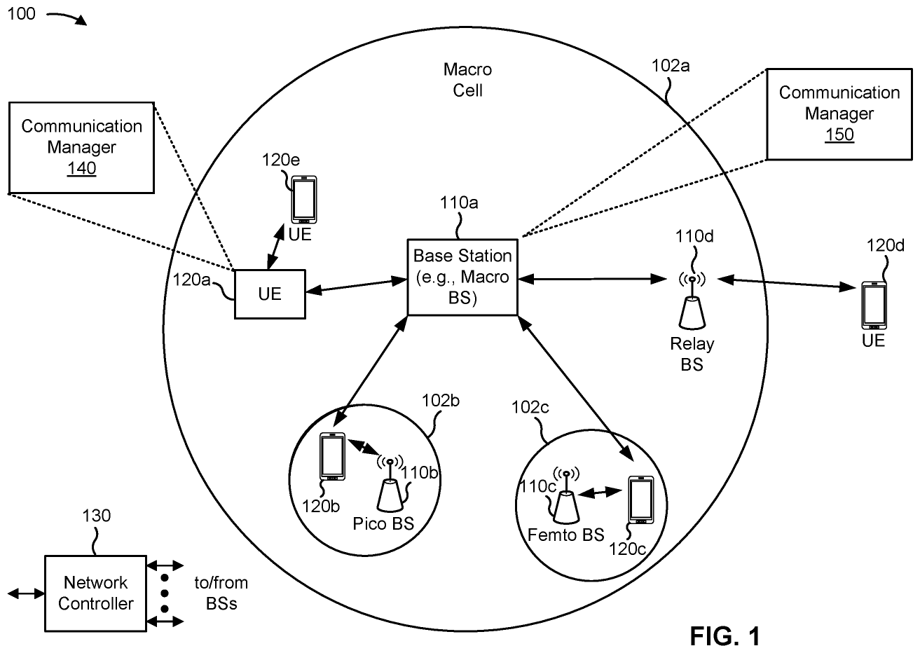

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any transport network.

The wireless network 100 may include one or more relay stations. A relay station is an entity and/or node that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other device, system, apparatus, or the like that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first node (e.g., a UE, a base station, a CU, a DU, or an RU, among other examples) may include a communication manager 140 or 150. As described in more detail elsewhere herein, the communication manager 140 or 150 may transmit an indication of a first set of one or more groups, wherein each group of the first set of one or more groups includes respective one or more parameter values corresponding to digital non-linearity transmission modeling supported by the first node; and receive an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception. Additionally, or alternatively, the communication manager 140 or 150 may perform one or more other operations described herein.

In some aspects, a first node (e.g., a UE, a base station, a CU, a DU, or an RU, among other examples) may include a communication manager 140 or 150. As described in more detail elsewhere herein, the communication manager 140 or 150 may receive an indication of a first set of one or more groups, wherein each group of the first set of one or more groups includes respective one or more parameter values corresponding to digital non-linearity transmission modeling supported by the first node; and transmit an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception. Additionally, or alternatively, the communication manager 140 or 150 may perform one or more other operations described herein.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

As indicated above, FIG. 1 is provided as an example. Other examples may differ from what is described with regard to FIG. 1.

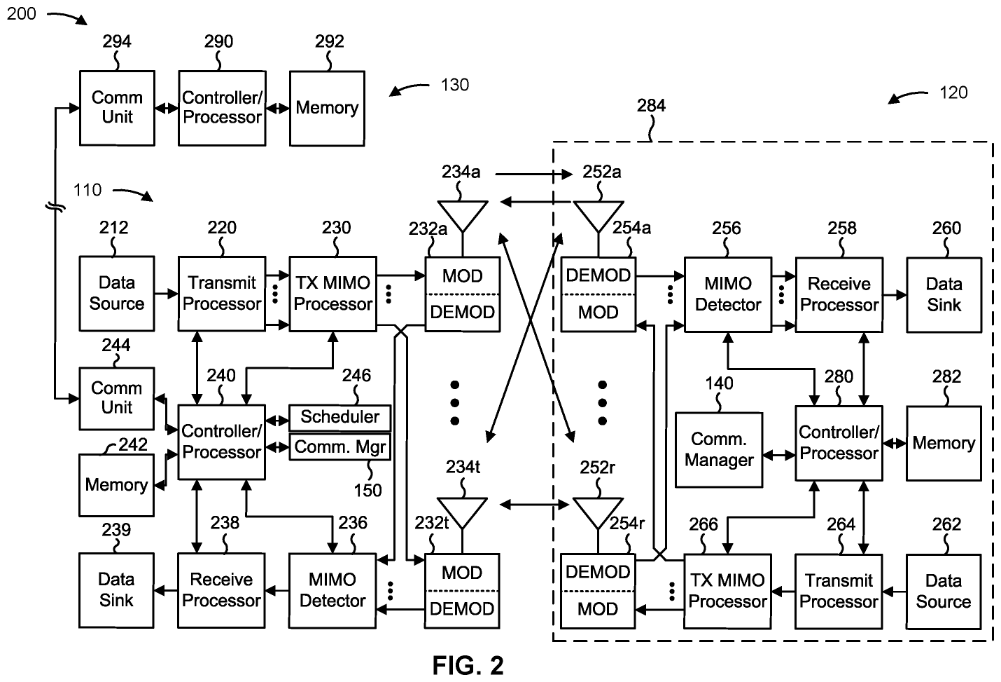

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended or destined for the UE 120 (or a set of UEs 120). The transmit processor 220 may select one or more modulation and coding schemes (MCSs) for the UE 120 based on one or more channel quality indicators (CQIs) received from that UE 120. The base station 110 may process (e.g., encode and modulate) the data for the UE 120 based on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

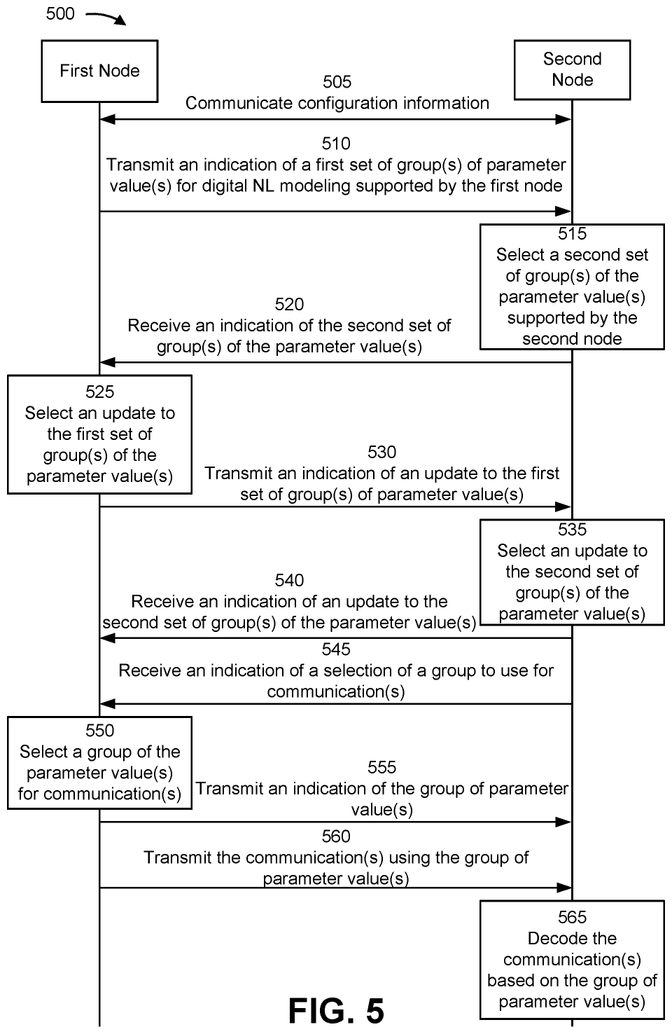

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

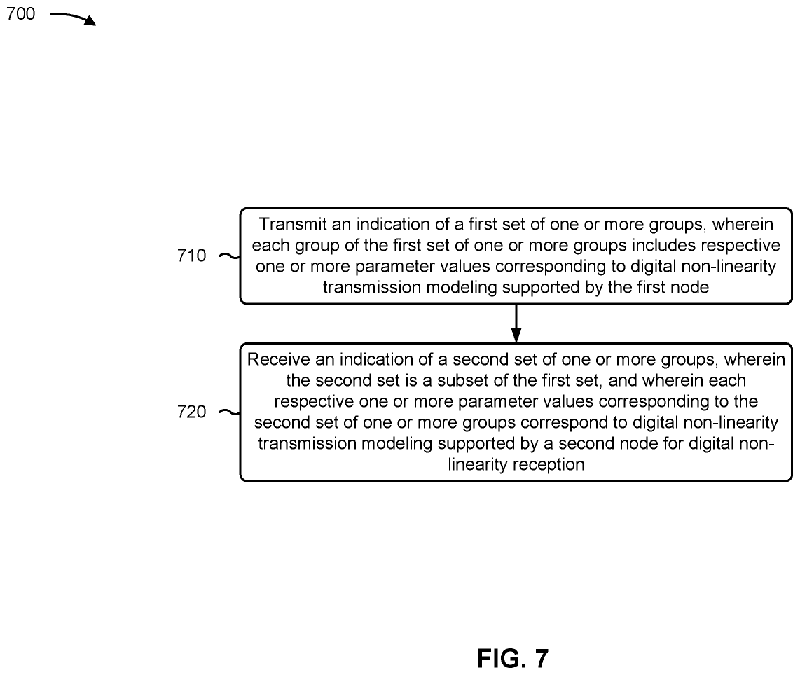

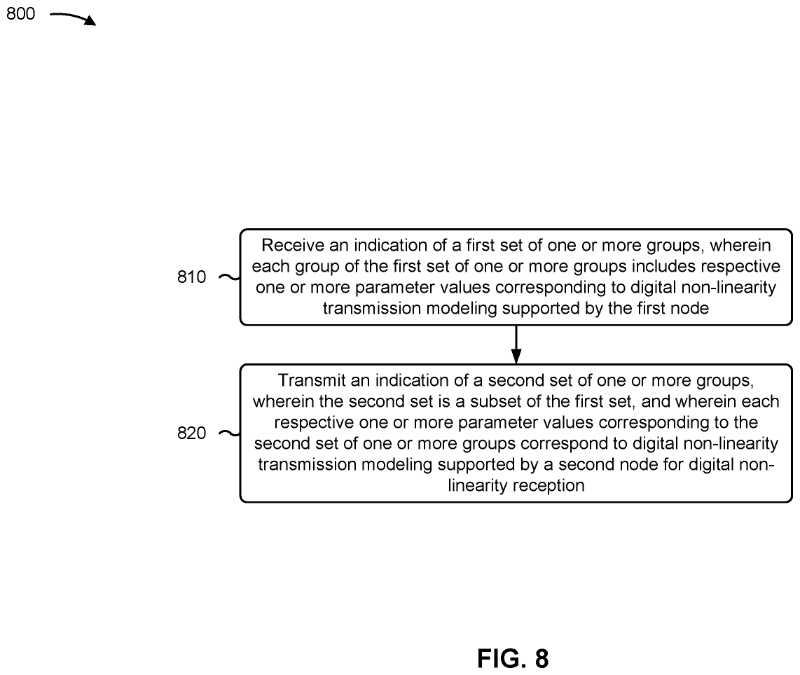

The controller/processor 240 of the base station 110, the controller/processor 280 of the UE 120, and/or any other component(s) of FIG. 2 may perform one or more techniques associated with digital NL modeling, as described in more detail elsewhere herein. In some aspects, the network node (e.g., the first network node or the second network node) described herein is the UE 120, is included in the UE 120, or includes one or more components of the UE 120 shown in FIG. 2. In some aspects, the network node (e.g., the first network node or the second network node) described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a first node includes means for transmitting an indication of a first set of one or more groups, wherein each group of the first set of one or more groups includes respective one or more parameter values corresponding to digital non-linearity transmission modeling supported by the first node; and/or means for receiving an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception. In some aspects, the means for the first node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the first node to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a first node includes means for receiving an indication of a first set of one or more groups, wherein each group of the first set of one or more groups includes respective one or more parameter values corresponding to digital non-linearity transmission modeling supported by the first node; and/or means for transmitting an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception. In some aspects, the means for the first node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the first node to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

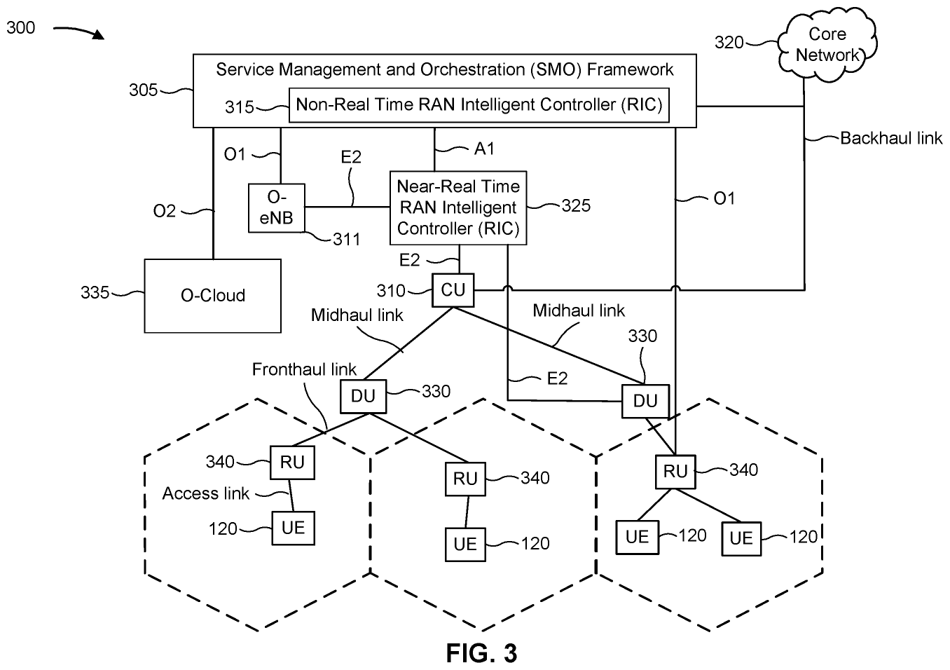

FIG. 3 is a diagram illustrating an example 300 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameter values or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

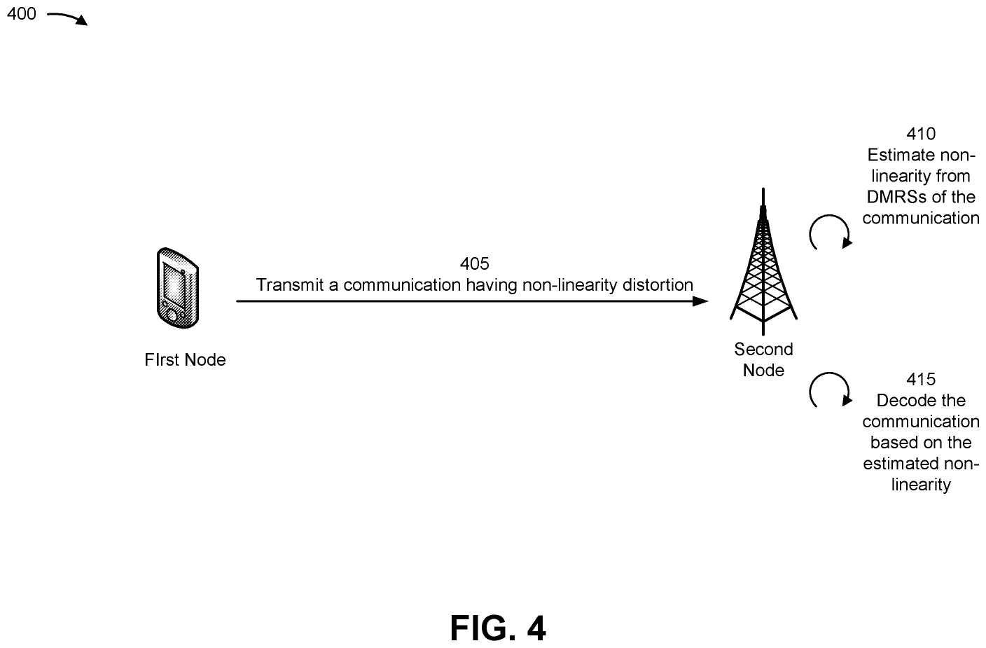

FIG. 4 is a diagram illustrating an example 400 of communicating using NL distortion, in accordance with the present disclosure. As shown in FIG. 4, a first node and a second node may communicate based on transmitting communications with NL distortion and attempting to decode communications with NL distortion. The first node may include or may be included in a UE (e.g., UE 120) or a network node (e.g., base station 110). The second node may include or may be included in a UE (e.g., UE 120) or a network node (e.g., base station 110).

As shown by reference number 405, the first node may transmit, and the second node may receive, a communication having NL distortion. The first node may transmit the communication having NL distortion based on the transmitting device (e.g., in a transmission chain) using non-linear components, such as high-power power amplifiers (PAs) with limited linear dynamic range (DR), and polynomial response. The NL distortions may be classified as in-band distortion, which affects a link performance (e.g., an error vector magnitude (EVM)), and an out-band distortion, which corresponds to an amount of adjacent channel interference.

To reduce NL distortions, power output back-off (boOut) may be used to reduce a transmission power used to transmit the communication. However an increase in boOut may cause a reduction in power amplifier efficiency (PAE). The reduction of PAE may correspond to a reduction of power transmitted on the channel and an increase in energy dissipated as heat.

As shown by reference number 410, the second node may estimate NL of the communication using demodulation reference signals (DMRSs) or other reference signals of the communication. For example, the second node may use a sequence associated with the DMRSs to estimate NL distortion of the signal and to correct a received signal for the NL distortion. This may include digital post distortion (DPOD) correction. In this way, the transmitting device may reduce or eliminate boOut, which may increase PAE, with the receiving device correcting for the NL distortion at reception.

As shown by reference number 415, the second node may decode the communication based on the estimated NL of the communication.

To perform DPOD, the second node uses an NL model of the first node. In some networks, the second node may estimate and/or measure the NL model from DMRSs and use the NL model for the DPOD processing. However, estimating and/or measuring the NL model from DMRSs may have increasing difficulty (e.g., lower accuracy and/or a consumption of increased computing resources of the second node) with higher NL in the transmission. For example, estimating and/or measuring the NL model from DMRSs may be limited by thermal noise in frequency selective channels. In some networks, a peak-to-average-power ratio (PAPR) target of an NL transmission may impact an ability of the second node to receive the communication based on a reduction in signal-to-noise ratio (SNR). In this way, estimating and/or measuring the NL model from DMRSs may consume computing resources and may increase error rates of communications, which may increase computing, power, network, and/or communication resources to detect and correct.

In some aspects described herein, a first node (also referenced as a transmitting node) may transmit an indication of an NL transmission model to a second node (also referenced as a second node). For example, the first node may use an NL function that may be a well-known mathematical operator, and the first node may indicate modeling and/or NL transmission model properties to the second node. In some aspects, the first node may transmit the indication using a reduced amount of overhead when compared to signaling a PA NL model.

In some aspects, a communication protocol or other specification may include a set of candidate NL transmission options. An option for the first node may include an indication of a number of iterations to perform NL operations, an indication of a linear filter used for each iteration, and/or an indication of an NL function used for each iteration. For example, the NL function may include a RAPP model:

$$\vert y \vert = \frac{\vert x \vert}{{( 1 + {( \frac{\vert x \vert}{A} )}^{2 \cdot p} )}^{\frac{1}{2 \cdot p}}}$$

where y is an output of the NL function, x is an input, and A is a power backoff.

In some aspects, the first node may transmit an indication (e.g., via a semi-static communication, a Layer 3 (L3) communication, a radio resource control (RRC) communication, a dynamic signaling communication, a Layer 2 (L2) communication, and/or a medium access control (MAC) layer communication, among other examples) that indicates a first set of one or more groups of one or more parameter values for digital NL transmission modeling supported by the first node. A group of the one or more parameter values may be associated with parameter values for a communication (e.g., a value for each parameter of a communication for NL operations). In some aspects, the indication may indicate the first set of one or more groups of the one or more parameter values from the set of candidate NL transmission options.

In some aspects, the first node may transmit an update and/or a supplemental indication associated with the first set of one or more groups. For example, the first node may indicate support for a group that includes one or more parameter values that are not included in the set of candidate NL transmission options. The update and/or the supplemental indication may include an indication of a number of iterations to perform NL operations, an indication of a linear filter used for each iteration, and/or an indication of an NL function used for each iteration associated with any additional groups of one or more parameter values supported by the first node. In some aspects, the update and/or the supplemental indication may indicate that the first node does not support one or more groups previously indicated as supported in the first set of groups.

In some aspects, the second node may transmit an indication (e.g., via a semi-static communication, an L3 communication, an RRC communication, a dynamic signaling communication, an L2 communication, and/or a MAC layer communication, among other examples) of a second set of one or more groups of the one or more parameter values for digital NL transmission modeling supported by the second node for digital NL reception. The second set may be a subset of the first set.

In some aspects, the first node may transmit an indication (e.g., via a dynamic signaling communication, a Layer 1 (L1) communication, uplink control information (UCI), downlink control information (DCI), a control channel communication, an L2 communication, and/or a MAC layer communication, among other examples) of a group of one or more parameter values that the first node will use for one or more communications. For example, the first node may indicate the group via an index associated with the second set of one or more groups.

In some aspects, the second node (e.g., a base station or a network node, among other examples) may transmit an indication (e.g., via a dynamic signaling communication, an L1 communication, UCI, DCI, a control channel communication, an L2 communication, and/or a MAC layer communication, among other examples) of a group of one or more parameter values for the first node to use for one or more communications.

In some aspects, the second node may transmit an indication of rules that define when to use different groups of the second set of groups. For example, the second node may indicate that a first group is to be used based on one or more conditions, such as a modulation and coding scheme (MCS), a rank index, a number of component carriers, an integrated bandwidth (IBW), an occupied bandwidth (OBW), a component carrier location, a time of day, and/or a geo-location of the first node or the second node, among other examples.

In some aspects, the first node includes or is included in a UE. In some aspects, the second node includes or is included in a network node (e.g., a base station and/or a DU, a CU, or an RU, among other examples).

Based on the first node transmitting an indication of a digital NL transmission model, the second node may have improved accuracy in restoring the SNR in a communication. In this way, the first node may transmit with increased power, which may improve PAE and/or conserve power resources of the first node.

FIG. 5 is a diagram of an example 500 associated with digital NL modeling, in accordance with the present disclosure. As shown in FIG. 5, a first node (e.g., a UE 120, a base station 110, a CU, a DU, and/or an RU) may communicate with a second node (e.g., a UE 120, a base station 110, a CU, a DU, and/or an RU). In some aspects, the first node and the second node may be part of a wireless network (e.g., wireless network 100). The first node and the second node may have established a wireless connection prior to operations shown in FIG. 5. Although in the context of FIG. 5 the first node is referenced as a first node and the second node is referenced as a second node, designation as “first” or “second” is for ease of description of the nodes. In other context, the first node of FIG. 5 may be referenced as a second node and the second node of FIG. 5 may be referenced as a first node.

As shown by reference number 505, the first node and the second node may communicate configuration information. In some aspects, the first node and the second node may communicate the configuration information via one or more of radio resource control (RRC) signaling, one or more MAC control elements (CEs), sidelink control information (SCI), UCI, and/or DCI, among other examples. In some aspects, the configuration information may include an indication of one or more configuration parameter values (e.g., already known to the first node and the second node and/or previously indicated by another network device) for selection by the first node and the second node, and/or explicit configuration information, among other examples.

In some aspects, the configuration information may indicate that the first node is to transmit an indication of a first set of one or more groups of one or more parameter values for digital NL modeling supported by the first node. In some aspects, the configuration information may indicate that the second node is to select, and/or transmit an indication of, a second set of one or more groups (e.g., from the first set of groups) supported by the second node. In some aspects, the configuration information may indicate that the first node is to select, and/or transmit an indication of, a group of the one or more parameter values (e.g., from the second set of groups) for one or more communications. In some aspects, the configuration information may indicate one or more candidate groups of one or more parameter values from which the first node may select the one or more groups of the first set of one or more groups.

In some aspects, the configuration information may indicate that the first node and/or the second node may transmit indications of updates to the first set of groups and/or the second set of groups. In some aspects, the configuration information may indicate one or more operations and/or processes to transmit the indications of updates.

The first node and the second node may configure themselves based on the configuration information. In some aspects, the UE may be configured to perform one or more operations described herein based on the configuration information.

As shown by reference number 510, the first node may transmit, and the second node may receive, an indication of a first set of one or more groups of one or more parameter values for digital NL modeling supported by the first node. For example, the first node may transmit an indication of a first set of one or more groups, wherein each group of the first set of one or more groups includes respective one or more parameter values corresponding to digital non-linearity transmission modeling supported by the first node.

In some aspects, the one or more parameter values may include one or more parameters for NL operations to be applied by the first node on an input signal. For example, the one or more parameters may include, or may correspond to, a nonlinearity function applied to an input to generate an output signal, a linear filter applied to the input to generate the output signal, and/or a number of iterations of performance of one or more functions or filters before transmission, among other examples.

In some aspects, the first node may transmit the indication via a semi-static communication, an L3 communication, an RRC communication, a dynamic signaling communication, an L2 communication, and/or a MAC layer communication, among other examples.

As shown by reference number 515, the second node may select a second set of one or more groups of the one or more parameter values supported by the second node. For example, the second node may select the second set of one or more groups as a subset of the first set of one or more groups.

As shown by reference number 520, the first node may receive, and the second node may transmit, an indication of the second set of one or more groups of the one or more parameter values. The second set of one or more groups of the one or more parameter values may indicate support by the second node for use in digital NL reception. For example, each respective one or more parameter values corresponding to the second set of one or more groups may correspond to digital non-linearity transmission modeling supported by a second node for digital non-linearity reception. The second set may be a subset of the first set. In some aspects, the second set may include a single group of the one or more parameter values, which may indicate that the first node is to use the single group of the one or more parameter values for one or more communications.

In some aspects, the second node may transmit the indication via a semi-static communication, an L3 communication, an RRC communication, a dynamic signaling communication, an L2 communication, and/or a MAC layer communication, among other examples.

In some aspects, the indication of the second set of one or more groups may indicate one or more rules for determining when to use different groups of the second set of one or more groups. For example, the indication of the second set of one or more groups of the one or more parameter values may include an indication of a first group of the second set of one or more groups, the first group to be used for first communications satisfying a first set of one or more first conditions. Additionally, or alternatively, the indication may include an indication of a second group of the second set of one or more groups, the second set to be used for second communications satisfying a second set of one or more second conditions, among other examples. The one or more first conditions and/or the one or more second conditions may correspond to MCSs for the first communications or the second communications, rank indices for the first communications or the second communications, numbers of component carriers for the first communications or the second communications, locations of component carriers for the first communications or the second communications, integrated bandwidths for the first communications or the second communications, occupied bandwidths for the first communications or the second communications, timing of the first communications or the second communications, and/or a geolocation of the first node, among other examples.

As shown by reference number 525, the first node may select an update to the first set of one or more groups of the one or more parameter values (e.g., supported by the first node). In some aspects, the first node may determine to update the first set of one or more groups based on a change in available power resources, available computing resources, and/or available communication resource, among other examples. For example, the first node may add one or more groups to the first set of one or more groups and/or the first node may remove one or more groups from the first set of one or more groups. In some aspects, the one or more groups added to the first set of one or more groups may not be included in the set of candidate groups (e.g., the one or more groups added may not be defined in a communication protocol or specification).

As shown by reference number 530, the first node may transmit, and the second node may receive, an indication of the update to the first set of the one or more groups of the one or more parameter values. In some aspects, the update to the first set of one or more groups includes an indication of one or more additional groups, where each group of the one or more additional groups includes respective one or more parameter values corresponding to digital non-linearity transmission modeling supported by the first node and where the respective one or more parameter values included in the first set of one or more groups or being one or more additional parameter values that the first node supports. In some aspects, the update to the first set of one or more groups includes an indication of one or more additional parameter values that the first node supports, an indication of the one or more additional parameter values, and/or an indication of one or more groups of the first set of one or more groups that the first node does not support, among other examples.

In some aspects, the first node may transmit the indication via a semi-static communication, an L3 communication, an RRC communication, a dynamic signaling communication, an L2 communication, and/or a MAC layer communication, among other examples.

As shown by reference number 535, the second node may select an update to the second set of one or more groups of the one or more parameter values (e.g., supported by the second node). In some aspects, the second node may determine to update the second set of one or more groups based on a change in available power resources, available computing resources, and/or available communication resource, among other examples. In some aspects, the second node may determine to update the second set of one or more groups based on receiving the indication of the update to the first set of one or more groups. Alternatively, the second node may determine to update the second set of one or more groups independently from (e.g., in the absence of) receiving the indication of the update to the first set of one or more groups. In some aspects, the second node may add one or more groups to the second set of one or more groups and/or the first node may remove one or more groups from the second set of one or more groups.

As shown by reference number 540, the first node may receive, and the second node may transmit, an indication of the update to the second set of the one or more groups of the one or more parameter values. In some aspects, the update may include a single group of the one or more parameter values, which may indicate that the first node is to use the single group of the one or more parameter values for one or more communications. In some aspects, the update to the second set of one or more groups of the one or more parameter values includes an indication of one or more additional groups of the one or more parameter values or one or more additional parameter values that the second node supports, an indication of the one or more additional parameter values, or an indication of one or more groups of the second set of one or more groups that the second node does not support, among other examples.

In some aspects, the second node may transmit the indication via a semi-static communication, an L3 communication, an RRC communication, a dynamic signaling communication, an L2 communication, and/or a MAC layer communication, among other examples.

As shown by reference number 545, the first node may receive, and the second node may transmit, an indication of a selection of a group to use for one or more communications. For example, the second node may transmit an indication of a group from the second set of one or more groups to use for one or more communications. In some aspects, the group may be a particular group of the second set of one or more of the one or more parameter values to use for one or more communications.

In some aspects, the second node may transmit the indication via a dynamic signaling communication, an L1 communication, UCI, DCI, a control channel communication, an L2 communication, and/or a MAC layer communication, among other examples.

As shown by reference number 550, the first node may select a group of the one or more parameter values for one or more communications. For example, the first node may select the group based on the indication of the second set of the one or more groups of the one or more parameter values, the indication of the update to the second set of one or more groups of the one or more parameter values, and/or the indication of the selection of the group to use for the one or more communications, among other examples. In some aspects, the first node may select the group based on one or more conditions at the first node and/or one or more conditions of a communication channel between the first node and the second node, among other examples. In some aspects, the group may be a particular group of the one or more parameter values, with the particular group being included in the second set of one or more groups and/or in the update to the second set of one or more groups.

As shown by reference number 555, the first node may transmit, and the second node may receive, an indication of the group of one or more parameter values. For example, the first node may transmit an indication of a particular group of the one or more parameter values for one or more communications transmitted by the first node, with the particular group being included in the second set of one or more groups of the one or more parameter values. Alternatively, the particular group may not be included in the second set of one or more groups and/or may be based on the second set of one or more groups (e.g., a group of the one or more groups). In some aspects, the first node may transmit the indication via a dynamic signaling communication, an L1 communication, UCI, DCI, a control channel communication, an L2 communication, and/or a MAC layer communication, among other examples.

As shown by reference number 560, the first node may transmit, and the second node may receive, the one or more communications using the group of the one or more parameter values. For example, the first node may transmit the one or more communications using a group of one or more parameter values based on the second set of one or more groups of the one or more parameter values. In some aspects, the first node may transmit the one or more communications using the group based on the second set of one or more groups (e.g., based on being in the second set of the one or more groups).

As shown by reference number 565, the second node may decode the one or more communications based on the group of one or more parameter values.

Based on the first node transmitting an indication of a digital NL transmission model, the second node may have improved accuracy in restoring the SNR in a communication. In this way, the first node may transmit with increased power, which may improve PAE and/or conserve power resources of the first node.

As indicated above, FIG. 5 is provided as an example. Other examples may differ from what is described with regard to FIG. 5.

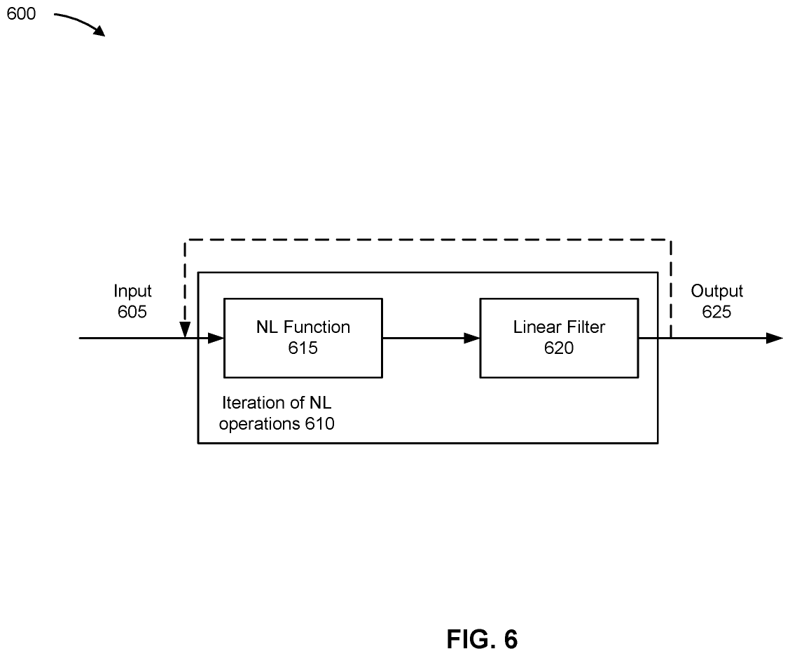

FIG. 6 is a diagram of an example 600 associated with digital NL modeling, in accordance with the present disclosure. In connection with FIG. 6, a first node (e.g., a UE 120, a base station 110, a CU, a DU, and/or an RU) may communicate with a second node (e.g., a UE 120, a base station 110, a CU, a DU, and/or an RU). In some aspects, the first node and the second node may be part of a wireless network (e.g., wireless network 100). The first node and the second node may have established a wireless connection prior to operations shown in FIG. 6.

As shown in FIG. 6, a set of NL operations may include receiving an input 605. An iteration 610 of NL operations may include an NL function 615 and/or a linear filter 620. Each iteration of the NL operations may include providing the input 605 to the NL function 615 and from the NL function 615 to the linear filter 620. After performing a configured number of iterations 610 of the NL operations, the NL operations generate an output 625. The first node may transmit the output (e.g., after performing one or more additional operations, such as front end unit operations, among other examples).

In some aspects, one or more parameters for NL operations may include the linear filter 620, the NL function 615, and/or a number of iterations 610 of the NL operations, among other examples.

As indicated above, FIG. 6 is provided as an example. Other examples may differ from what is described with regard to FIG. 6.

FIG. 7 is a diagram illustrating an example process 700 performed, for example, by a first node, in accordance with the present disclosure. Example process 700 is an example where the first node (e.g., a UE, a CU, a DU, an RU, or a base station) performs operations associated with digital non-linearity modeling.

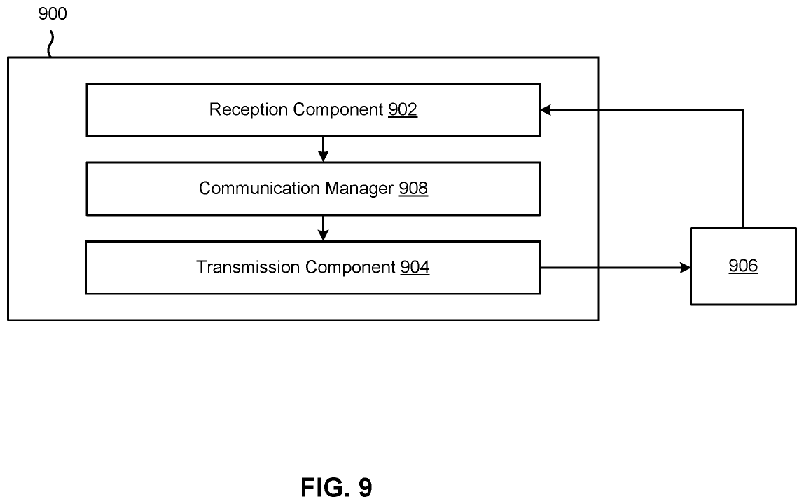

As shown in FIG. 7, in some aspects, process 700 may include transmitting an indication of a first set of one or more groups, wherein each group of the first set of one or more groups includes respective one or more parameter values corresponding to digital non-linearity transmission modeling supported by the first node (block 710). For example, the first node (e.g., using communication manager 140 or 150 and/or transmission component 904, depicted in FIG. 9) may transmit an indication of a first set of one or more groups, wherein each group of the first set of one or more groups includes respective one or more parameter values corresponding to digital non-linearity transmission modeling supported by the first node, as described above.

As further shown in FIG. 7, in some aspects, process 700 may include receiving an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception (block 720). For example, the first node (e.g., using communication manager 140 or 150 and/or reception component 902, depicted in FIG. 9) may receive an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception, as described above.

Process 700 may include additional aspects, such as any single aspect or any combination of aspects described below and/or in connection with one or more other processes described elsewhere herein.

In a first aspect, process 700 includes transmitting an indication of a particular group of the one or more parameter values for one or more communications transmitted by the first node, the particular group being included in the second set of one or more groups of the one or more parameter values.

In a second aspect, alone or in combination with the first aspect, process 700 includes transmitting one or more communications using a group of one or more parameter values based on the second set of one or more groups of the one or more parameter values.

In a third aspect, alone or in combination with one or more of the first and second aspects, the second set of one or more groups comprises a single group, wherein the method further comprises transmitting one or more communications using a group of one or more parameter values that is based on the single group of the one or more parameter values.

In a fourth aspect, alone or in combination with one or more of the first through third aspects, process 700 includes receiving an indication of a particular group of the second set of one or more groups to use for one or more communications.

In a fifth aspect, alone or in combination with one or more of the first through fourth aspects, the one or more parameter values correspond to one or more of a nonlinearity function applied to an input to generate an output signal, a linear filter applied to the input to generate the output signal, or a number of iterations of performance of one or more functions or filters before transmission of the output signal.

In a sixth aspect, alone or in combination with one or more of the first through fifth aspects, process 700 includes transmitting an indication of an update to the first set of one or more groups.

In a seventh aspect, alone or in combination with one or more of the first through sixth aspects, the update to the first set of one or more groups comprises one or more of an indication of one or more additional groups, wherein each group of the one or more additional groups includes respective one or more parameter values corresponding to digital non-linearity transmission modeling supported by the first node, the respective one or more parameter values included in the first set of one or more groups or being one or more additional parameter values that the first node supports, an indication of the one or more additional parameter values supported by the first node, or an indication of one or more groups of the first set of one or more groups that the first node does not support.

In an eighth aspect, alone or in combination with one or more of the first through seventh aspects, process 700 includes receiving an indication of an update to the second set of one or more groups.

In a ninth aspect, alone or in combination with one or more of the first through eighth aspects, the update to the second set of one or more groups comprises one or more of an indication of one or more additional groups, wherein each group of the one or more additional groups includes respective one or more parameter values corresponding to digital non-linearity transmission modeling supported by the first node, the respective one or more parameter values included in the first set of one or more groups or being one or more additional parameter values that the second node supports, an indication of the one or more additional parameter values, or an indication of one or more groups of the second set of one or more groups that the second node does not support.

In a tenth aspect, alone or in combination with one or more of the first through ninth aspects, the indication of the second set of one or more groups comprises an indication of a first group of the second set of one or more groups, the first group to be used for first communications satisfying a first set of one or more first conditions, and an indication of a second group of the second set of one or more groups, the second set to be used for second communications satisfying a second set of one or more second conditions.

In an eleventh aspect, alone or in combination with one or more of the first through tenth aspects, the first set of the one or more first conditions or the second set of the one or more second conditions correspond to one or more of MCSs for the first communications or the second communications, ranking indices for the first communications or the second communications, numbers of component carriers for the first communications or the second communications, locations of component carriers for the first communications or the second communications, integrating bandwidths for the first communications or the second communications, occupying bandwidths for the first communications or the second communications, timing of the first communications or the second communications, or a geolocation of the first node.

In a twelfth aspect, alone or in combination with one or more of the first through eleventh aspects, the first node comprises a user equipment, or a network node.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a first node, in accordance with the present disclosure. Example process 800 is an example where the first node (e.g., a UE, a CU, a DU, an RU, or a base station) performs operations associated with digital non-linearity modeling.

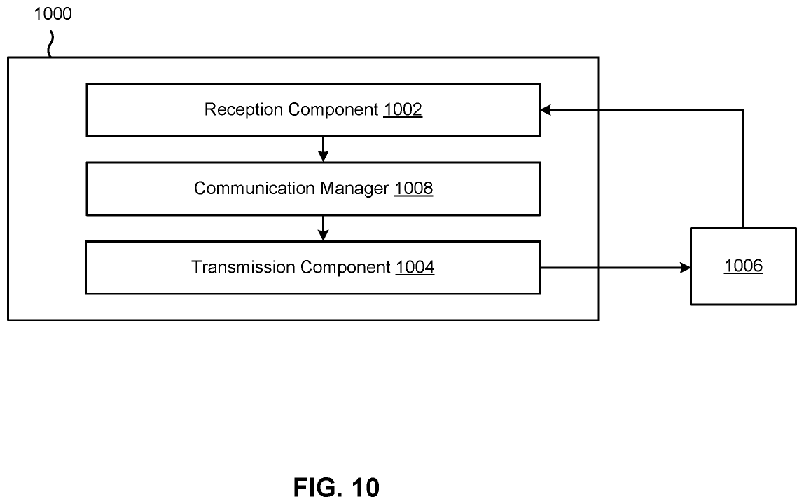

As shown in FIG. 8, in some aspects, process 800 may include receiving an indication of a first set of one or more groups, wherein each group of the first set of one or more groups includes respective one or more parameter values corresponding to digital non-linearity transmission modeling supported by the first node (block 810). For example, the first node (e.g., using communication manager 140 or 150 and/or reception component 1002, depicted in FIG. 10) may receive an indication of a first set of one or more groups, wherein each group of the first set of one or more groups includes respective one or more parameter values corresponding to digital non-linearity transmission modeling supported by the first node, as described above.

As further shown in FIG. 8, in some aspects, process 800 may include transmitting an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception (block 820). For example, the first node (e.g., using communication manager 140 or 150 and/or transmission component 1004, depicted in FIG. 10) may transmit an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception, as described above.

Process 800 may include additional aspects, such as any single aspect or any combination of aspects described below and/or in connection with one or more other processes described elsewhere herein.

In a first aspect, process 800 includes receiving an indication of a particular group of the one or more parameter values for one or more communications transmitted by the first node, the particular group being included in the second set of one or more groups of the one or more parameter values.

In a second aspect, alone or in combination with the first aspect, process 800 includes receiving one or more communications using a group of one or more parameter values based on the second set of one or more groups of the one or more parameter values.

In a third aspect, alone or in combination with one or more of the first and second aspects, the second set of one or more groups comprises a single group, wherein the method further comprises transmitting one or more communications using a group of one or more parameter values that is based on the single group of the one or more parameter values.

In a fourth aspect, alone or in combination with one or more of the first through third aspects, process 800 includes transmitting an indication of a particular group of the second set of one or more groups to use for one or more communications.

In a fifth aspect, alone or in combination with one or more of the first through fourth aspects, the one or more parameter values correspond to one or more of a nonlinearity function applied to an input to generate an output signal, a linear filter applied to the input to generate the output signal, or a number of iterations of performance of one or more functions or filters before transmission of the output signal.

In a sixth aspect, alone or in combination with one or more of the first through fifth aspects, process 800 includes receiving an indication of an update to the first set of one or more groups.

In a seventh aspect, alone or in combination with one or more of the first through sixth aspects, the update to the first set of one or more groups of the one or more parameter values comprises one or more of an indication of one or more additional groups, wherein each group of the one or more additional groups includes respective one or more parameter values corresponding to digital non-linearity transmission modeling supported by the first node, the respective one or more parameter values included in the first set of one or more groups or being one or more additional parameter values that the second node supports, an indication of the one or more additional parameter values supported by the second node, or an indication of one or more groups of the first set of one or more groups that the second node does not support.

In an eighth aspect, alone or in combination with one or more of the first through seventh aspects, process 800 includes transmitting an indication of an update to the second set of one or more groups.

In a ninth aspect, alone or in combination with one or more of the first through eighth aspects, the update to the second set of one or more groups of the one or more parameter values comprises one or more of an indication of one or more additional groups, wherein each group of the one or more additional groups includes respective one or more parameter values corresponding to digital non-linearity transmission modeling supported by the first node, the respective one or more parameter values included in the first set of one or more groups or being one or more additional parameter values that the first node supports, an indication of the one or more additional parameter values, or an indication of one or more groups of the second set of one or more groups that the first node does not support.

In a tenth aspect, alone or in combination with one or more of the first through ninth aspects, the indication of the second set of one or more groups comprises an indication of a first group of the second set of one or more groups, the first group to be used for first communications satisfying a first set of one or more first conditions, and an indication of a second group of the second set of one or more groups, the second set to be used for second communications satisfying a second set of one or more second conditions.

In an eleventh aspect, alone or in combination with one or more of the first through tenth aspects, the first set of the one or more first conditions or the second set of the one or more second conditions correspond to one or more of MCSs for the first communications or the second communications, ranking indices for the first communications or the second communications, numbers of component carriers for the first communications or the second communications, locations of component carriers for the first communications or the second communications, integrating bandwidths for the first communications or the second communications, occupying bandwidths for the first communications or the second communications, timing of the first communications or the second communications, or a geolocation of the second node.

In a twelfth aspect, alone or in combination with one or more of the first through eleventh aspects, the first node comprises a user equipment, or a network node.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a first node, or a first node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a communication manager 908 (e.g., the communication manager 140 or 150).

In some aspects, the apparatus 900 may be configured to perform one or more operations described herein in connection with FIG. 5-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the first node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the first node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the first node described in connection with FIG. 2. In some aspects, the transmission component 904 may be co-located with the reception component 902 in a transceiver.

The transmission component 904 may transmit an indication of a first set of one or more groups, wherein each group of the first set of one or more groups includes respective one or more parameter values corresponding to digital non-linearity transmission modeling supported by the first node. The reception component 902 may receive an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.

The transmission component 904 may transmit an indication of a particular group of the one or more parameter values for one or more communications transmitted by the first node, the particular group being included in the second set of one or more groups of the one or more parameter values.

The transmission component 904 may transmit one or more communications using a group of one or more parameter values based on the second set of one or more groups of the one or more parameter values.

The reception component 902 may receive an indication of a particular group of the second set of one or more groups to use for one or more communications.

The transmission component 904 may transmit an indication of an update to the first set of one or more groups.

The reception component 902 may receive an indication of an update to the second set of one or more groups.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a first node, or a first node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008 (e.g., the communication manager 140 or 150).

In some aspects, the apparatus 1000 may be configured to perform one or more operations described herein in connection with FIGS. 5-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the first node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the first node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the first node described in connection with FIG. 2. In some aspects, the transmission component 1004 may be co-located with the reception component 1002 in a transceiver.

The reception component 1002 may receive an indication of a first set of one or more groups, wherein each group of the first set of one or more groups includes respective one or more parameter values corresponding to digital non-linearity transmission modeling supported by the first node. The transmission component 1004 may transmit an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.

The reception component 1002 may receive an indication of a particular group of the one or more parameter values for one or more communications transmitted by the first node, the particular group being included in the second set of one or more groups of the one or more parameter values.

The reception component 1002 may receive one or more communications using a group of one or more parameter values based on the second set of one or more groups of the one or more parameter values.

The transmission component 1004 may transmit an indication of a particular group of the second set of one or more groups to use for one or more communications.

The reception component 1002 may receive an indication of an update to the first set of one or more groups.

The transmission component 1004 may transmit an indication of an update to the second set of one or more groups.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a first node, comprising: transmitting an indication of a first set of one or more groups, wherein each group of the first set of one or more groups includes respective one or more parameter values corresponding to digital non-linearity transmission modeling supported by the first node; and receiving an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.
Aspect 2: The method of Aspect 1, further comprising: transmitting an indication of a particular group of the one or more parameter values for one or more communications transmitted by the first node, the particular group being included in the second set of one or more groups of the one or more parameter values.
Aspect 3: The method of any of Aspects 1-2, further comprising: transmitting one or more communications using a group of one or more parameter values based on the second set of one or more groups of the one or more parameter values.
Aspect 4: The method of any of Aspects 1-3, wherein the second set of one or more groups comprises a single group, wherein the method further comprises transmitting one or more communications using a group of one or more parameter values that is based on the single group of the one or more parameter values.
Aspect 5: The method of any of Aspects 1-4, further comprising: receiving an indication of a particular group of the second set of one or more groups to use for one or more communications.
Aspect 6: The method of any of Aspects 1-5, wherein the one or more parameter values correspond to one or more of: a nonlinearity function applied to an input to generate an output signal, a linear filter applied to the input to generate the output signal, or a number of iterations of performance of one or more functions or filters before transmission of the output signal.
Aspect 7: The method of any of Aspects 1-6, further comprising: transmitting an indication of an update to the first set of one or more groups.
Aspect 8: The method of Aspect 7, wherein the update to the first set of one or more groups comprises one or more of: an indication of one or more additional groups, wherein each group of the one or more additional groups includes respective one or more parameter values corresponding to digital non-linearity transmission modeling supported by the first node, the respective one or more parameter values included in the first set of one or more groups or being one or more additional parameter values that the first node supports, an indication of the one or more additional parameter values supported by the first node, or an indication of one or more groups of the first set of one or more groups that the first node does not support.
Aspect 9: The method of any of Aspects 1-8, further comprising: receiving an indication of an update to the second set of one or more groups.
Aspect 10: The method of Aspect 9, wherein the update to the second set of one or more groups comprises one or more of: an indication of one or more additional groups, wherein each group of the one or more additional groups includes respective one or more parameter values corresponding to digital non-linearity transmission modeling supported by the first node, the respective one or more parameter values included in the first set of one or more groups or being one or more additional parameter values that the second node supports, an indication of the one or more additional parameter values, or an indication of one or more groups of the second set of one or more groups that the second node does not support.
Aspect 11: The method of any of Aspects 1-10, wherein the indication of the second set of one or more groups comprises: an indication of a first group of the second set of one or more groups, the first group to be used for first communications satisfying a first set of one or more first conditions, and an indication of a second group of the second set of one or more groups, the second set to be used for second communications satisfying a second set of one or more second conditions.
Aspect 12: The method of Aspect 11, wherein the first set of the one or more first conditions or the second set of the one or more second conditions correspond to one or more of: modulation and coding schemes (MCSs) for the first communications or the second communications, rank indices for the first communications or the second communications, numbers of component carriers for the first communications or the second communications, locations of component carriers for the first communications or the second communications, integrated bandwidths for the first communications or the second communications, occupied bandwidths for the first communications or the second communications, timing of the first communications or the second communications, or a geolocation of the first node.
Aspect 13: The method of any of Aspects 1-12, wherein the first node comprises: a user equipment, or a network node.
Aspect 14: A method of wireless communication performed by a first node, comprising: receiving an indication of a first set of one or more groups, wherein each group of the first set of one or more groups includes respective one or more parameter values corresponding to digital non-linearity transmission modeling supported by the first node; and transmitting an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.
Aspect 15: The method of Aspect 14, further comprising: receiving an indication of a particular group of the one or more parameter values for one or more communications transmitted by the first node, the particular group being included in the second set of one or more groups of the one or more parameter values.
Aspect 16: The method of any of Aspects 14-15, further comprising: receiving one or more communications using a group of one or more parameter values based on the second set of one or more groups of the one or more parameter values.
Aspect 17: The method of any of Aspects 14-16, wherein the second set of one or more groups comprises a single group, wherein the at least one processor is configured to transmit one or more communications using a group of one or more parameter values that is based on the single group of the one or more parameter values.
Aspect 18: The method of any of Aspects 14-17, further comprising: transmitting an indication of a particular group of the second set of one or more groups to use for one or more communications.
Aspect 19: The method of any of Aspects 14-18, wherein the one or more parameter values correspond to one or more of: a nonlinearity function applied to an input to generate an output signal, a linear filter applied to the input to generate the output signal, or a number of iterations of performance of one or more functions or filters before transmission of the output signal.
Aspect 20: The method of any of Aspects 14-19, further comprising: receiving an indication of an update to the first set of one or more groups.
Aspect 21: The method of Aspect 20, wherein the update to the first set of one or more groups of the one or more parameter values comprises one or more of: an indication of one or more additional groups, wherein each group of the one or more additional groups includes respective one or more parameter values corresponding to digital non-linearity transmission modeling supported by the first node, the respective one or more parameter values included in the first set of one or more groups or being one or more additional parameter values that the second node supports, an indication of the one or more additional parameter values supported by the second node, or an indication of one or more groups of the first set of one or more groups that the second node does not support.
Aspect 22: The method of any of Aspects 14-21, further comprising: transmitting an indication of an update to the second set of one or more groups.
Aspect 23: The method of Aspect 22, wherein the update to the second set of one or more groups of the one or more parameter values comprises one or more of: an indication of one or more additional groups, wherein each group of the one or more additional groups includes respective one or more parameter values corresponding to digital non-linearity transmission modeling supported by the first node, the respective one or more parameter values included in the first set of one or more groups or being one or more additional parameter values that the first node supports, an indication of the one or more additional parameter values, or an indication of one or more groups of the second set of one or more groups that the first node does not support.
Aspect 24: The method of any of Aspects 14-23, wherein the indication of the second set of one or more groups comprises: an indication of a first group of the second set of one or more groups, the first group to be used for first communications satisfying a first set of one or more first conditions, and an indication of a second group of the second set of one or more groups, the second set to be used for second communications satisfying a second set of one or more second conditions.
Aspect 25: The method of Aspect 24, wherein the first set of the one or more first conditions or the second set of the one or more second conditions correspond to one or more of: modulation and coding schemes (MCSs) for the first communications or the second communications, rank indices for the first communications or the second communications, numbers of component carriers for the first communications or the second communications, locations of component carriers for the first communications or the second communications, integrated bandwidths for the first communications or the second communications, occupied bandwidths for the first communications or the second communications, timing of the first communications or the second communications, or a geolocation of the second node.
Aspect 26: The method of any of Aspects 14-25, wherein the first node comprises: a user equipment, or a network node.
Aspect 27: An apparatus for wireless communication at a device, comprising a processor; memory coupled with the processor; and instructions stored in the memory and executable by the processor to cause the apparatus to perform the method of one or more of Aspects 1-26.
Aspect 28: A device for wireless communication, comprising a memory and one or more processors coupled to the memory, the one or more processors configured to perform the method of one or more of Aspects 1-26.
Aspect 29: An apparatus for wireless communication, comprising at least one means for performing the method of one or more of Aspects 1-26.
Aspect 30: A non-transitory computer-readable medium storing code for wireless communication, the code comprising instructions executable by a processor to perform the method of one or more of Aspects 1-26.
Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first node for wireless communication, comprising:
a memory; and
one or more processors coupled to the memory, wherein the one or more processors are configured to:
transmit an indication of a first set of one or more groups, wherein each group of the first set of one or more groups includes respective one or more parameter values corresponding to digital non-linearity transmission modeling supported by the first node; and
receive an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.

2. The first node of claim 1, wherein the one or more processors are further configured to:
transmit an indication of a particular group of the one or more parameter values for one or more communications transmitted by the first node, the particular group being included in the second set of one or more groups of the one or more parameter values.

3. The first node of claim 1, wherein the one or more processors are further configured to:
transmit one or more communications using a group of one or more parameter values based on the second set of one or more groups of the one or more parameter values.

4. The first node of claim 1, wherein the second set of one or more groups comprises a single group, wherein the at least one processor is configured to transmit one or more communications using a group of one or more parameter values that is based on the single group of the one or more parameter values.

5. The first node of claim 1, wherein the one or more processors are further configured to:
receive an indication of a particular group of the second set of one or more groups to use for one or more communications.

6. The first node of claim 1, wherein the one or more parameter values correspond to one or more of:
a nonlinearity function applied to an input to generate an output signal,
a linear filter applied to the input to generate the output signal, or
a number of iterations of performance of one or more functions or filters before transmission of the output signal.

7. The first node of claim 1, wherein the one or more processors are further configured to:
transmit an indication of an update to the first set of one or more groups.

8. The first node of claim 7, wherein the update to the first set of one or more groups comprises one or more of:
an indication of one or more additional groups, wherein each group of the one or more additional groups includes respective one or more parameter values corresponding to digital non-linearity transmission modeling supported by the first node, the respective one or more parameter values included in the first set of one or more groups or being one or more additional parameter values that the first node supports,
an indication of the one or more additional parameter values supported by the first node, or
an indication of one or more groups of the first set of one or more groups that the first node does not support.

9. The first node of claim 1, wherein the one or more processors are further configured to:
receive an indication of an update to the second set of one or more groups.

10. The first node of claim 9, wherein the update to the second set of one or more groups comprises one or more of:
an indication of one or more additional groups, wherein each group of the one or more additional groups includes respective one or more parameter values corresponding to digital non-linearity transmission modeling supported by the first node, the respective one or more parameter values included in the first set of one or more groups or being one or more additional parameter values that the second node supports,
an indication of the one or more additional parameter values, or
an indication of one or more groups of the second set of one or more groups that the second node does not support.

11. The first node of claim 1, wherein the indication of the second set of one or more groups comprises:
an indication of a first group of the second set of one or more groups, the first group to be used for first communications satisfying a first set of one or more first conditions, and
an indication of a second group of the second set of one or more groups, the second set to be used for second communications satisfying a second set of one or more second conditions.

12. The first node of claim 11, wherein the first set of the one or more first conditions or the second set of the one or more second conditions correspond to one or more of:
modulation and coding schemes (MCSs) for the first communications or the second communications,
rank indices for the first communications or the second communications,
numbers of component carriers for the first communications or the second communications,
locations of component carriers for the first communications or the second communications,
integrated bandwidths for the first communications or the second communications,
occupied bandwidths for the first communications or the second communications,
timing of the first communications or the second communications, or
a geolocation of the first node.

13. The first node of claim 1, wherein the first node comprises:
a user equipment, or
a network node.

14. A first node for wireless communication, comprising:
a memory; and
one or more processors coupled to the memory, wherein the one or more processors are configured to:
receive an indication of a first set of one or more groups, wherein each group of the first set of one or more groups includes respective one or more parameter values corresponding to digital non-linearity transmission modeling supported by the first node; and
transmit an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.

15. The first node of claim 14, wherein the one or more processors are further configured to:
receive an indication of a particular group of the one or more parameter values for one or more communications transmitted by the first node, the particular group being included in the second set of one or more groups of the one or more parameter values.

16. The first node of claim 14, wherein the one or more processors are further configured to:
receive one or more communications using a group of one or more parameter values based on the second set of one or more groups of the one or more parameter values.

17. The first node of claim 14, wherein the second set of one or more groups comprises a single group, wherein the at least one processor is configured to transmit one or more communications using a group of one or more parameter values that is based on the single group of the one or more parameter values.

18. The first node of claim 14, wherein the one or more processors are further configured to:
transmit an indication of a particular group of the second set of one or more groups to use for one or more communications.

19. The first node of claim 14, wherein the one or more parameter values correspond to one or more of:
a nonlinearity function applied to an input to generate an output signal,
a linear filter applied to the input to generate the output signal, or
a number of iterations of performance of one or more functions or filters before transmission of the output signal.

20. The first node of claim 14, wherein the one or more processors are further configured to:
receive an indication of an update to the first set of one or more groups.

21. The first node of claim 20, wherein the update to the first set of one or more groups of the one or more parameter values comprises one or more of:
an indication of one or more additional groups, wherein each group of the one or more additional groups includes respective one or more parameter values corresponding to digital non-linearity transmission modeling supported by the first node, the respective one or more parameter values included in the first set of one or more groups or being one or more additional parameter values that the second node supports,
an indication of the one or more additional parameter values supported by the second node, or
an indication of one or more groups of the first set of one or more groups that the second node does not support.

22. The first node of claim 14, wherein the one or more processors are further configured to:
transmit an indication of an update to the second set of one or more groups.

23. The first node of claim 22, wherein the update to the second set of one or more groups of the one or more parameter values comprises one or more of:
an indication of one or more additional groups, wherein each group of the one or more additional groups includes respective one or more parameter values corresponding to digital non-linearity transmission modeling supported by the first node, the respective one or more parameter values included in the first set of one or more groups or being one or more additional parameter values that the first node supports,
an indication of the one or more additional parameter values, or
an indication of one or more groups of the second set of one or more groups that the first node does not support.

24. The first node of claim 14, wherein the indication of the second set of one or more groups comprises:
an indication of a first group of the second set of one or more groups, the first group to be used for first communications satisfying a first set of one or more first conditions, and
an indication of a second group of the second set of one or more groups, the second set to be used for second communications satisfying a second set of one or more second conditions.

25. The first node of claim 24, wherein the first set of the one or more first conditions or the second set of the one or more second conditions correspond to one or more of:
modulation and coding schemes (MCSs) for the first communications or the second communications,
rank indices for the first communications or the second communications,
numbers of component carriers for the first communications or the second communications,
locations of component carriers for the first communications or the second communications,
integrated bandwidths for the first communications or the second communications,
occupied bandwidths for the first communications or the second communications,
timing of the first communications or the second communications, or
a geolocation of the second node.

26. The first node of claim 14, wherein the first node comprises:
a user equipment, or
a network node.

27. A method of wireless communication performed by a first node, comprising:
transmitting an indication of a first set of one or more groups, wherein each group of the first set of one or more groups includes respective one or more parameter values corresponding to digital non-linearity transmission modeling supported by the first node; and
receiving an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.

28. The method of claim 27, further comprising:
transmitting one or more communications using a group of one or more parameter values based on the second set of one or more groups of the one or more parameter values.

29. A method of wireless communication performed by a first node, comprising:
receiving an indication of a first set of one or more groups, wherein each group of the first set of one or more groups includes respective one or more parameter values corresponding to digital non-linearity transmission modeling supported by the first node; and
transmit an indication of a second set of one or more groups, wherein the second set is a subset of the first set, and wherein each respective one or more parameter values corresponding to the second set of one or more groups correspond to digital non-linearity transmission modeling supported by a second node for digital non-linearity reception.

30. The method of claim 29, further comprising:
receiving one or more communications using a group of one or more parameter values based on the second set of one or more groups of the one or more parameter values.
